(19) United States
(12) Patent Application Publication
(10) Pub. No.: US 2006/0164859 A1
(43) Pub. Date: Jul. 27, 2006

(54) Integration rod and method for inhibiting stray light

(76) Inventor: Brian Chiang, Chunghe City (TW)

Correspondence Address: LEONG C LEI, PMB # 1008, 1867 YGNACIO VALLEY ROAD, WALNUT CREEK, CA, 94598, US

(21) Appl. No.: 11/042,108

(22) Filed: Jan. 26, 2005

(51) Int. Cl. F21V 8/00

(52) U.S. Cl. 362/582

(57) ABSTRACT

A method and an integration rod for inhibiting stray lights in a projection device are provided. The integration rod is a hollow cylindrical rod formed by two pairs of parallel lenses. Each of the lenses has its inner surface plated with a reflection film. Lights enter and leave the integration rod via its two terminal ends. The lenses have one or both of their terminal ends shielded to block the lights from entering or leaving via the terminal ends of the lenses, so as to inhibit the generation of stray lights.

### BACKGROUND OF THE INVENTION

(a) Technical Field of the Invention

The present invention generally relates to projection devices, and more particularly to a method and an integration rod structure for inhibiting the generation of stray lights in the projection devices.

(b) Description of the Prior Art

Currently commercially available projection devices, based on the optical mechanism used, could be categorized into those based on transparent LCD (liquid crystal display), reflective DMD (digital micro device), or reflective LCOS (liquid crystal on silicon).

FIG. 6 is a schematic diagram showing the structure of a transparent LCD-based projection device. As shown in FIG. 6, the luminous flux A, generated by a light source 10 and then reflected by a parabolic reflection mirror 11, is focused on a color wheel 13 by a first converging lens assembly 12. The luminous flux A is then converted into a colored luminous flux A1 by sequentially intercepting the flux A with the red, green, and blue filters of the color wheel 13. Then, the colored flux A1 is uniformed by passing through a hollow integration rod 20. After that, the colored flux A1 reaches an optical device 17, which is the transparent LCD, after undergoing the adjustment by a second converging lens assembly 14, a grating 15, and a third converging lens assembly 16. At the end, the image on the optical device 17 is projected to a screen 19 by an imaging device 18.

FIG. 7 is a schematic diagram showing the structure of a reflective DMD-based projection device. As shown in FIG. 7, the luminous flux A, generated by a light source 10 and then reflected by a parabolic reflection mirror 11, is focused on a color wheel 13 by a first converging lens assembly 12. The luminous flux A is then converted into a colored luminous flux A1 by sequentially intercepting the flux A with the red, green, and blue filters of the color wheel 13. Then, the colored flux A1 is uniformed by passing through a hollow integration rod 20. After that, the colored flux A1 reaches an optical device 17, which is the reflective DMD, after undergoing the adjustment by a second converging lens assembly 14, a grating 15, and a third converging lens assembly 16. At the end, the image on the optical device 17 is refracted to an imaging device 18 and projected to a screen 19 by the imaging device 18.

FIG. 8 is a schematic diagram showing the structure of a reflective LCOS-based projection device. As shown in FIG. 8, the luminous flux A, generated by a light source 10 and then reflected by a parabolic reflection mirror 11, is focused on a color wheel 13 by a first converging lens assembly 12. The luminous flux A is then converted into a colored luminous flux A1 by sequentially intercepting the flux A with the red, green, and blue filters of the color wheel 13. Then, the colored flux A1 is uniformed by passing through a hollow integration rod 20. After that, the colored flux A1 reaches an optical device 17, which is the reflective LCOS, after undergoing the adjustment by a second converging lens assembly 14, a grating 15, and a third converging lens assembly 16. At the end, the image on the optical device 17 is refracted to an imaging device 18 and projected to a screen 19 by the imaging device 18.

As can be seen from the foregoing description, the integration rod is a major component of various types of projection devices. Incident lights are uniformed by the integration rod after undergoing multiple full reflections by the reflective inner surfaces inside the hollow cylindrical rod. The uniformed lights help to enhance the contrast and resolution of the final projected image.

FIGS. 9 and 10 are schematic diagrams showing the structure of a conventional integration rod 20. As shown, the integration rod 20 is a hollow cylindrical rod formed by two pairs of parallel lenses 21. Each of the lenses 21 has its inner surface plated with a reflection film 22. Lights enter the integration rod 20 from one end and leave the integration rod 20 form the other end. The two ends are hereinafter referred to as the light entering end 23 and the light exiting end 24 respectively.

According to the foregoing working principle of the integration rod 20, as long as the lights enter the integration rod 20 via the opening of the light entering end 23, the lights would undergo multiple full reflections and get uniformed. However, as shown in FIG. 10, lights in reality wouldn't enter the integration rod 20 entirely via the opening of the light entering end 23. A portion of them would enter into and leave the lenses 21 all via the lenses 21's two end surfaces at the light entering end 23 and the light exiting end 24 respectively. In addition, due to an inferior film-plating process, some incident lights already inside the hollow integration rod 20 might not be fully reflected by the reflection film 22 and thereby might enter the lenses 21 via their inner surface as well. These lights would also emit out of the integration rod 20 via the lenses 21's end surfaces at the light exiting end 24. Since the refraction index of the lenses 21 is different from that of the hollow section of the integration rod 20, lights in the lenses 21 and lights in the hollow section of the integration rod 20 would be refracted differently and the uniformity of lights are thereby comprised. The lights inside the lenses 21 would undergo more times of refraction and would form red, green, and blue colored stripes around the lights emitted out of the hollow section of the integration rod 20. These stray lights from the integration rod 20 would serious impair the projection quality, which is totally unacceptable for projection devices requiring high contrast and resolution.

To eliminate the stray lights in the projection devices, Republic of China, Taiwan, Patent No. 566,786 disclosed a method employing a light blocking plate. The light blocking plate is installed between the projection device's reflection mirror and the screen, so that the stray lights are prevented from being projected to the screen. The side of the light blocking plate for intercepting the stray lights is made of light absorption material. However, the teaching says nothing, explicitly or implicitly, about inhibiting stray lights from the integration rod. Republic of China, Taiwan, Patent No. 594,186 disclosed a projection system using a lighting structure with multiple light sources. The purpose of the lighting structure is to focus the lights from the multiple light sources directly on the integration rod to avoid stray lights. However, the teaching also does not mention anything about the stray lights generated by the integration rod itself.

### SUMMARY OF THE INVENTION

The primary purpose of the present invention is to provide a method for inhibiting the generation of stray lights in a projection device.

Specifically, the method for inhibiting the generation of stray lights provided by the present invention shields one or both ends of the lenses of an integration rod at the light entering and exiting ends. In this way, lights are prevented from entering or leaving the lenses via the lenses' ends, and the stray lights are thereby inhibited.

Another major objective of the present invention is to provide an integration rod structure to inhibit the generation of stray lights.

Specifically, the integration rod structure provided by the present invention is mainly a hollow cylindrical rod formed by two pairs of parallel lenses. Each of the lenses has its inner surface plated with a reflection film. One or both ends of the lenses of the integration rod at the light entering and exiting ends are shielded by a shielding layer. As such, lights are prevented from entering and leaving the lenses via the lenses' ends by the shielding layers, and the stray lights are thereby inhibited.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing the structure of an integration rod according to a first embodiment the present invention.

FIG. 2 is a sectional schematic diagram showing the light trajectories of an integration rod according to a first embodiment of the present invention.

FIG. 3 is a sectional schematic diagram showing the light trajectories of an integration rod according to a second embodiment of the present invention.

FIG. 4 is a sectional schematic diagram showing the light trajectories of an integration rod according to a third embodiment of the present invention.

FIG. 5 is a perspective explosion diagram showing the installation of the integration rod according to the present invention on the base of a projection device.

FIG. 6 is a schematic diagram showing the structure of a transparent LCD-based projection device.

FIG. 7 is a schematic diagram showing the structure of a reflective DMD-based projection device.

FIG. 8 is a schematic diagram showing the structure of a reflective LCOS-based projection device.

FIG. 9 is a schematic diagram showing the cross-section of a conventional integration rod.

FIG. 10 is a schematic diagram showing the light trajectories of a conventional integration rod.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

In the following, detailed description along with the accompanied drawings is given to better explain preferred embodiments of the present invention. Please note that some parts in the accompanied drawings are not drawn to scale or are somewhat exaggerated. It should be understood that this is for illustrative purpose, and is not intended to limit the present invention in any way.

The method for inhibiting the generation of stray lights provided by the present invention is mainly about shielding one or both ends of the lenses 21 of an integration rod 20 at the light entering and exiting ends 23, 24. Lights are thereby prevented from entering or leaving the lenses via the lenses' ends so as to inhibit the stray lights.

To shield the ends of the lenses 21 at the light entering and exiting ends 23, 24, any object that could reduce light transmission and fixedly adhere to the light entering and exiting ends 23, 24 could be adopted. Examples include a coated layer, a plating film, a metallic plate, or even a non-transparent piece of paper. In the preferred embodiments described below, a shielding layer 25 is formed by coating a non-transparent film or a cover that could reduce light transmission. The film could be a metallic plating film, a high reflection plating film, or other light eliminating material. The cover could be made of metallic, ceramic, or other heat-withstanding material.

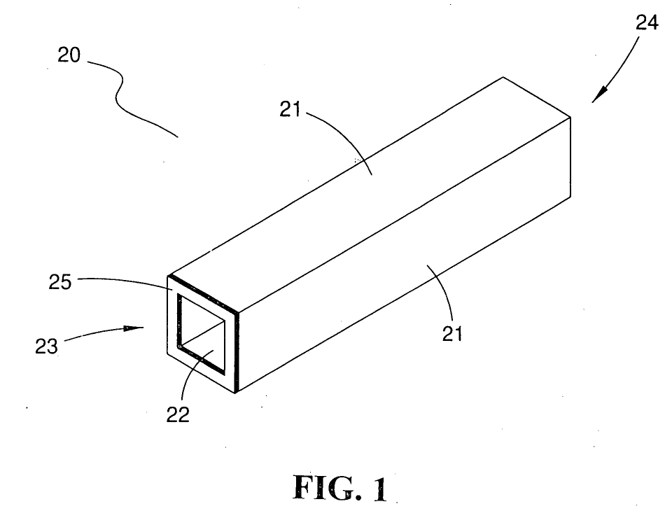

FIG. 1 is a perspective diagram showing the structure of an integration rod 20 according to a first embodiment the present invention. Integration rod 20 is a hollow cylindrical rod formed by two pairs of parallel lenses 21. Each of the lenses 21 has its inner surface plated with a reflection film 22. Lights enter the integration rod 20 from the light entering end 23 and leave the integration rod 20 form the light exiting end 24. On the surfaces of the lenses 21 at the light entering end 23, a shielding layer 25 is installed. The shielding layer 25 could a metallic plating film, a high reflection plating film, or other light eliminating material, formed by a coating process. The shielding layer 25 could also be a cover made of metallic, ceramic, or other heat-withstanding material.

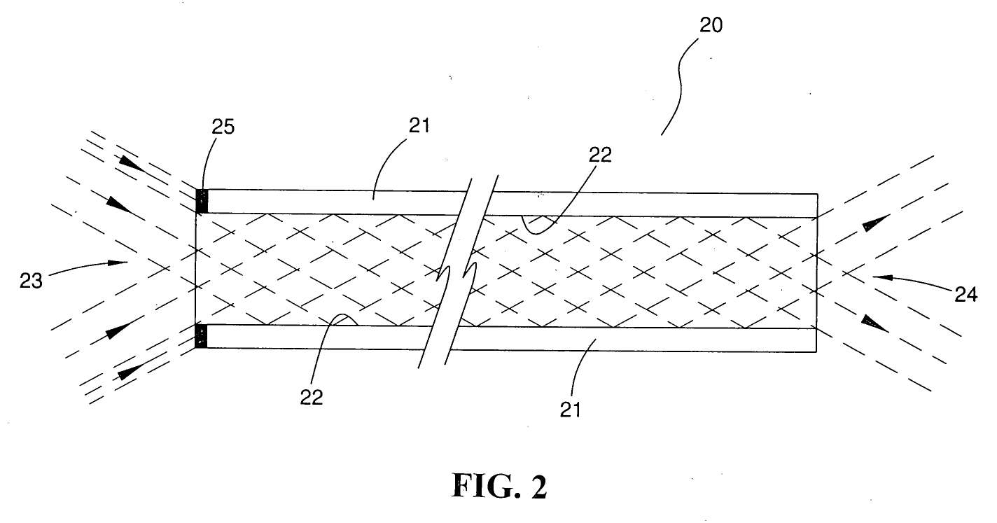

FIG. 2 is a sectional schematic diagram showing the light trajectories of an integration rod according to the first embodiment present invention. As shown in FIG. 2, lights enter the integration rod 20 mainly via the hollow section as the lenses 21 are shielded by the shielding layer 25 at the light entering end 23. Consequently, uniform lights are emitted from the hollow section of the integration rod 20 and the stray lights are thereby inhibited.

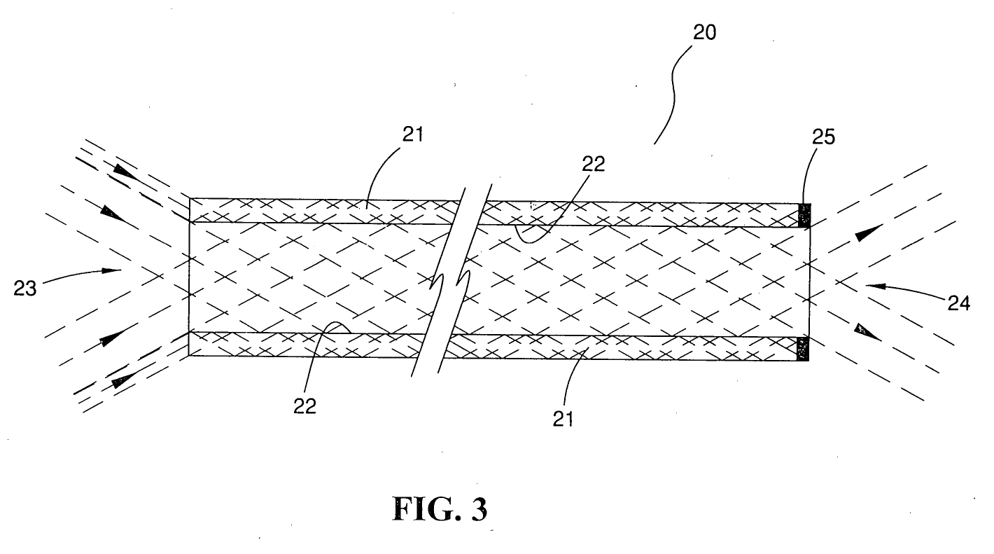

FIG. 3 is a sectional schematic diagram showing the light trajectories of an integration rod according to a second embodiment of the present invention. As shown in FIG. 3, the shielding layer 25 is installed at the lenses 21′ ends at the light exiting end 24. Therefore, lights inside the lenses 21 are blocked by the shielding layer 25 so that lights emitted form the integration rod 20 are mainly from the hollow section of the integration rod 20, which are uniformed by the integration rod 20. The stray lights are thereby inhibited.

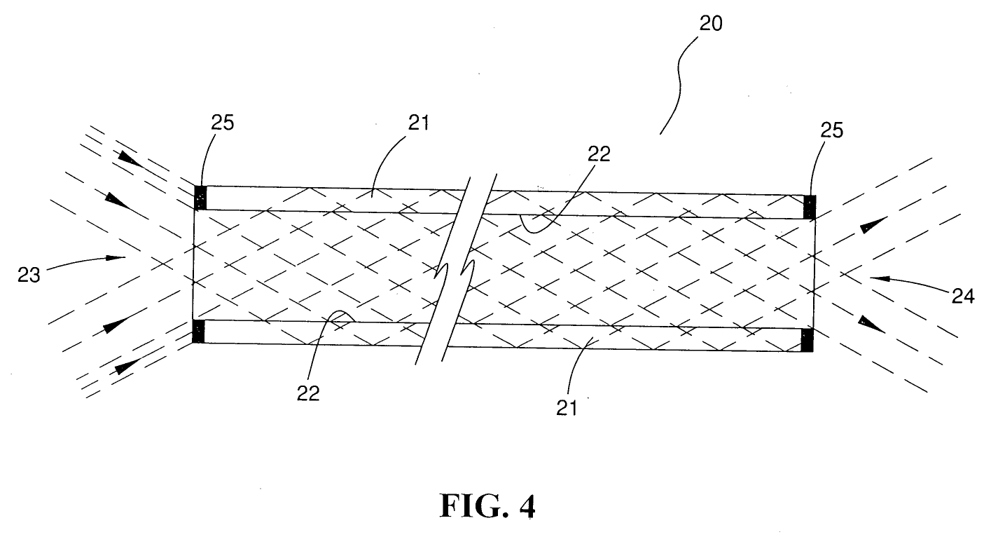

FIG. 4 is a sectional schematic diagram showing the light trajectories of an integration rod according to a third embodiment of the present invention. As shown in FIG. 4, shielding layers 25 are installed at the lenses 21′ ends at both the light entering and exiting ends 23, 24. Therefore, lights enter the integration rod 20 mainly via the hollow section as the lenses 21 are shielded by the shielding layer 25 at the light entering end 23. In addition, even though a small portion of lights penetrates the reflection film 22 and enters inside the lenses 21, they are blocked by the shielding layer 25 at the light exiting end 24. In this way, the projection quality could be further enhanced.

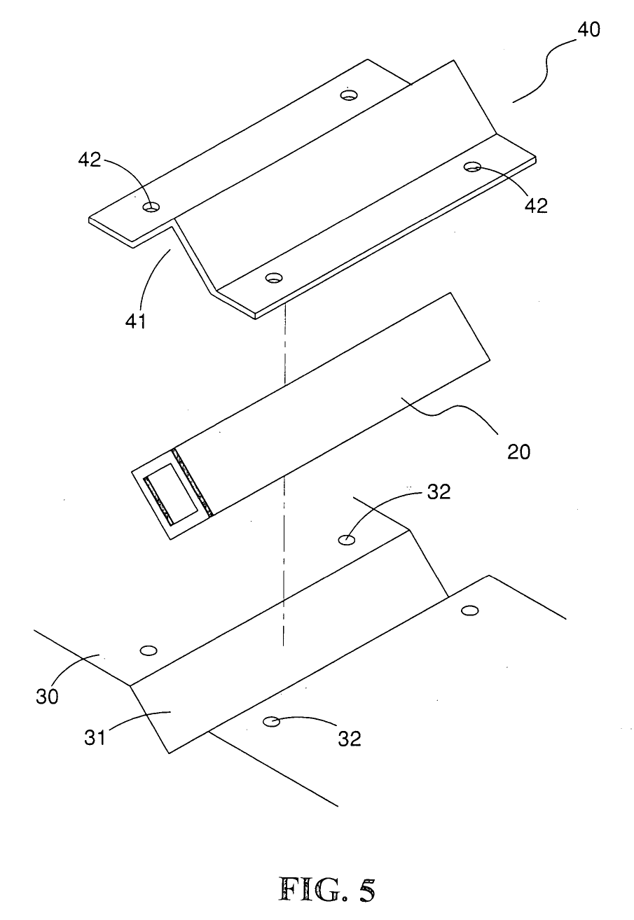

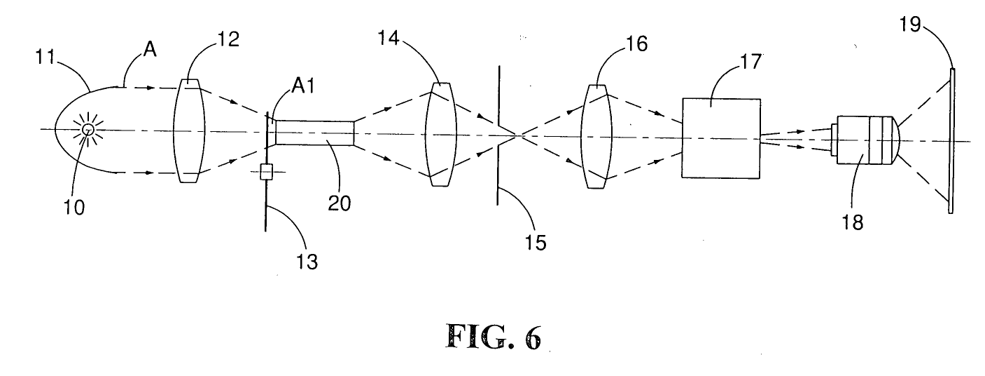

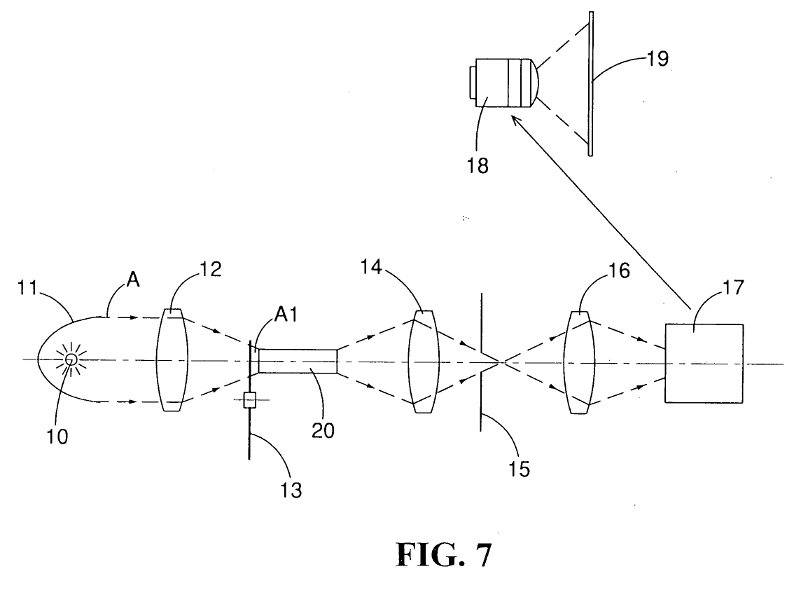

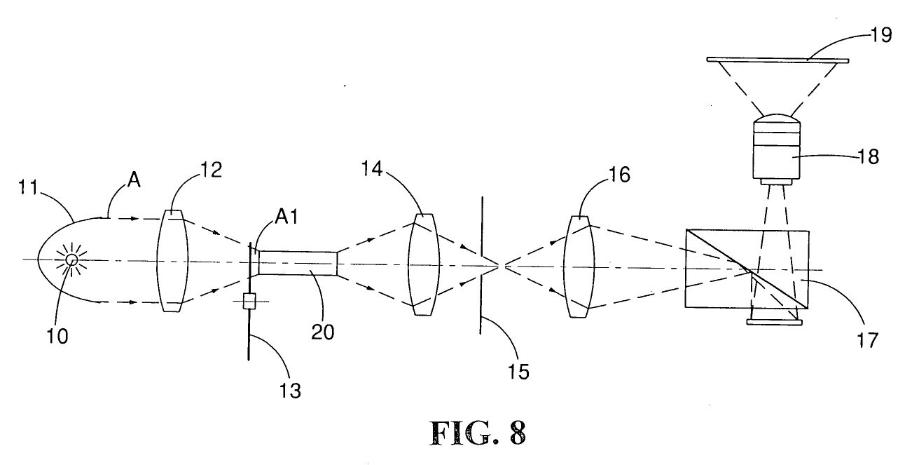

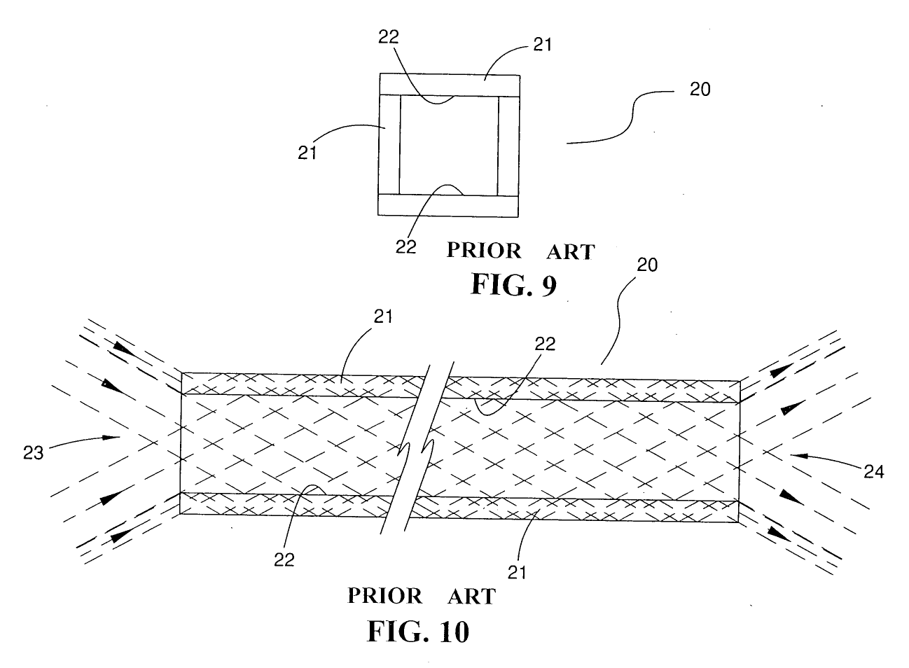

FIG. 5 is a perspective explosion diagram showing the installation of the integration rod 20 according to the present invention on the base 30 of a projection device. As shown in FIG. 5, the base 30 has a V-shaped groove 31, in which the integration rod 20 could be positioned with two of its adjacent surfaces matching the V shape. The other two surfaces of the integration rod 20 are exposed outside of the groove 31, and covered by a matching ˆ-shaped pressing plate 40. There are bolt holes 32 along the groove 31 on the base 30. The pressing plate 40, on the other hand, has through holes 42 at locations matching the bolt holes 32. The integration rod 20 could be fixedly locked between the base 30 and the pressing plate 40 by screwing them together.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A method for inhibiting stray lights in a projection device, which shields the ends of a plurality of lenses forming a hollow integration rod at said integration rod's light entering end to prevent incident lights from entering into said lenses.

2. A method for inhibiting stray lights in a projection device, which shields the ends of a plurality of lenses forming a hollow integration rod at said integration rod's light exiting ends to prevent lights from being emitted from said lenses.

3. A method for inhibiting stray lights in a projection device, which shields the ends of a plurality of lenses forming a hollow integration rod at both of said integration rod's light exiting end and light entering end to prevent incident lights from entering into said lenses and to prevent lights from being emitted from said lenses.

4. The method according to claim 1, wherein said lenses' ends at the light entering end of said integration rod are shielded by a shielding layer made of a material selected from the group consisting of metallic plating film, high reflection plating film, and a light eliminating material.

5. The method according to claim 1, wherein said lenses' ends at the light entering end of said integration rod are shielded by a shielding layer made of a material selected from the group consisting of metallic materials, ceramic materials, and a heat-withstanding material capable of reducing light transmission.

6. The method according to claim 2, wherein said lenses' ends at the light exiting ends of said integration rod are shielded by a shielding layer made of a material selected from the group consisting of metallic plating film, high reflection plating film, and a light eliminating material.

7. The method according to claim 2, wherein said lenses' ends at the light exiting ends of said integration rod are shielded by a shielding layer made of a material selected from the group consisting of metallic materials, ceramic materials, and a heat-withstanding material capable of reducing light transmission.

8. An integration rod of a projection device, which is a hollow cylindrical rod whose side wall is formed by a plurality of lenses, said integration rod has lights entering into one of its terminal ends and has lights emitted out of its another terminal ends, each of said lenses has its inner surface coated with a reflection film, and a shielding layer is installed on the ends of said lenses at said integration rod's light entering end.

9. An integration rod of a projection device, which is a hollow cylindrical rod whose side wall is formed by a plurality of lenses, said integration rod has lights entering into one of its terminal ends and has lights emitted out of its another terminal ends, each of said lenses has its inner surface coated with a reflection film, and a shielding layer is installed on the ends of said lenses at said integration rod's light exiting end.

10. An integration rod of a projection device, which is a hollow cylindrical rod whose side wall is formed by a plurality of lenses, said integration rod has lights entering into one of its terminal ends and has lights emitted out of its another terminal ends, each of said lenses has its inner surface coated with a reflection film, and shielding layers are installed on the ends of said lenses at said integration rod's both light entering and exiting ends.

11. The integration rod according to claim 8, wherein said shielding layer is made of a material selected from the group consisting of metallic plating film, high reflection plating film, and a light eliminating material.

12. The method according to claim 8, wherein said shielding layer is made of a material selected from the group consisting of metallic materials, ceramic materials, and a heat-withstanding material capable of reducing light transmission.

13. The integration rod according to claim 9, wherein said shielding layer is made of a material selected from the group consisting of metallic plating film, high reflection plating film, and a light eliminating material.

14. The method according to claim 9, wherein said shielding layer is made of a material selected from the group consisting of metallic materials, ceramic materials, and a heat-withstanding material capable of reducing light transmission.
